(19) United States
(12) Patent Application Publication
(10) Pub. No.: US 2025/0199875 A1
(43) Pub. Date: Jun. 19, 2025

(54) METHOD AND PLATFORM FOR COMPUTATIONAL OPTIMIZATION OF MACHINE LEARNING

(71) Applicant: CLOUD INTELLIGENCE ASSETS HOLDING (SINGAPORE) PRIVATE LIMITED, N/A (SG)

(72) Inventors: Hanyu ZHAO, Hangzhou (CN); Shiru REN, Beijing (CN); Yong LI, Beijing (CN)

(21) Appl. No.: 18/849,357

(22) PCT Filed: Mar. 15, 2023
(86) PCT No.: PCT/CN2023/081493

§ 371 Date: Sep. 20, 2024

(30) Foreign Application Priority Data
Mar. 23, 2022 (CN) 202210290092.6

(51) Int. Cl. G06F 9/50; G06F 9/48

(52) U.S. Cl. CPC G06F 9/5077; G06F 9/4881; G06F 9/5033

(57) ABSTRACT

Disclosed are a method and a platform for computational optimization of machine learning. The method includes: partitioning, through a partitioned edge, a machine learning computation graph into a data worker subgraph constituted by upstream nodes of stateful nodes and a training worker subgraph constituted by the stateful nodes and downstream nodes of the stateful nodes; and on each side of the partitioned edge, adding a data sending node to the data worker subgraph and adding a data receiving node to the training worker subgraph, respectively. By dividing the computation graph on the basis of whether a node is stateful or stateless and inserting communication nodes, a data worker and a training worker in a same task can be decoupled, so that general-purpose computational resources involved in the data worker at runtime can be dynamically allocated. Furthermore, through combining with a scheduler, the general-purpose computational resources can be scheduled across clusters.

### CROSS-REFERENCE TO RELATED APPLICATIONS

This application is a National Stage of International Application No. PCT/CN2023/081493, and filed on Mar. 15, 2023, which claims priority to Chinese Patent Application No. 202210290092.6, filed to the China National Intellectual Property Administration on Mar. 23, 2022 and entitled “METHOD AND PLATFORM FOR COMPUTATIONAL OPTIMIZATION OF MACHINE LEARNING”. The disclosures of the aforementioned applications are hereby incorporated by reference in their entireties.

### TECHNICAL FIELD

The present disclosure relates to the field of machine learning and, in particular, to a method and a platform for computational optimization of machine learning.

### BACKGROUND

Currently, data processing and training for deep learning tasks are located in a same segment of codes, and are compiled together and are running in a same machine. However, different deep learning tasks require general-purpose computational resources (such as Central Processing Units, CPUs) and dedicated computational resources (such as Graphics Processing Units (GPUs) and Application Specific Integrated Circuits (ASICs)) at significantly varied ratios, rendering that the hardware resource ratio for computing devices always fails to meet task requirements. Moreover, with improved computational capability of a single dedicated computational resource, a commonality in the prior art is that the general-purpose computational resources configured cannot provide sufficient data for the dedicated computational resources, resulting in reduced running efficiency of deep learning tasks caused by a mismatch between the general-purpose computational capability and the dedicated computational capability.

To this end, a solution is needed to solve the problem of low running efficiency of deep learning tasks due to a mismatch between hardware resources.

### SUMMARY

To solve the above problem, the present disclosure provides a method and a platform for computational optimization of machine learning. In the present scheme, a computation graph is divided on the basis of whether a node is stateful or stateless, and communication nodes are inserted, so that a data worker and a training worker in a deep learning task can be decoupled from each other, general-purpose computational resources involved in the data worker can be dynamically allocated based on efficiency of the training worker during running, thereby solving the problem that running efficiency of deep learning tasks is reduced due to incapability to provide sufficient pre-processing data for a dedicated computational unit such as a GPU. Furthermore, in the present scheme, a combination with a platform scheduler is possible, and the general-purpose computational resources can be scheduled across clusters, thereby breaking machine limits, and improving the overall hardware utilization efficiency of the platform.

According to a first aspect of the present disclosure, a method for computational optimization of machine learning is provided, including: identifying stateful nodes in a machine learning computation graph; partitioning, through a partitioned edge, the machine learning computation graph into a data worker subgraph constituted by upstream nodes of the stateful nodes and a training worker subgraph constituted by the stateful nodes and downstream nodes of the stateful nodes; and on each side of the partitioned edge, adding a data sending node to the data worker subgraph and adding a data receiving node to the training worker subgraph, respectively.

In an implementation, the method further includes: asynchronously executing the data worker subgraph and the training worker subgraph.

In an implementation, asynchronously executing the data worker subgraph and the training worker subgraph includes: dynamically scaling, based on a mismatch indicator between data generation of the data worker subgraph and data consumption of the training worker subgraph, an amount of CPU resources for execution of the data worker subgraph.

In an implementation, dynamically scaling the amount of CPU resources for execution of the data worker subgraph includes at least one of: when the mismatch indicator indicates a mismatch, increasing a number of CPU cores participating in execution of the data worker subgraph; and when the mismatch indicator indicates a mismatch, requesting for a new CPU resource for independent execution of the data worker subgraph.

In an implementation, after the new CPU resource is allocated, the data worker subgraph is replicated, data that is different from data selected for existing CPU resources for execution of the data worker subgraph is selected from a training dataset for processing, and processed data is sent to the same data receiving node.

In an implementation, asynchronously executing the data worker subgraph and the training worker subgraph includes: acquiring, by a data worker unit, a first predetermined amount of training data, and performing a pre-processing operation based on the data worker subgraph; sending pre-processed data from the data sending node to a pre-processing result storage queue; acquiring, by the data receiving node, the pre-processed data from the corresponding pre-processing result storage queue; and according to the pre-processed data, performing, by a training worker unit, a training operation based on the training worker subgraph.

In an implementation, sending the pre-processed data from the data sending node to the pre-processing result storage queue includes: maintaining, by a data receiving operator corresponding to the data receiving node, the pre-processing result storage queue, and continuously pulling the pre-processed data from the data sending node to the pre-processing result storage queue.

In an implementation, the data receiving node pulls a second predetermined amount of the pre-processed data from the pre-processing result storage queue each time and distributes a new index of the first predetermined amount of training data to the data worker unit.

In an implementation, partitioning, through a partitioned edge, the machine learning computation graph into the data worker subgraph constituted by the upstream nodes of the stateful nodes and the training worker subgraph constituted by the stateful nodes and the downstream nodes of the stateful nodes includes: starting from all the stateful nodes in the computation graph for performing model parameter updating, searching for and finding all the downstream nodes, to obtain a set of nodes and an edge thereof that constitute the training worker subgraph; performing a search from a source node, to obtain a set of nodes excluding the nodes of the training worker subgraph, and obtaining the data worker subgraph.

According to a second aspect of the present disclosure, a method for computational optimization of machine learning is provided, including: acquiring, by a data worker unit performing computation based on a CPU, a first predetermined amount of training data and performing a pre-processing operation based on a data worker subgraph, and sending pre-processed data via a data sending node; acquiring, by a training worker unit performing deep learning computation based on a heterogeneous processing unit, the pre-processed data via a data receiving node to perform a training operation based on the training worker subgraph, where a computation graph of a current machine learning task is partitioned, through a partitioned edge, into the data worker subgraph constituted by upstream nodes of the stateful nodes and the training worker subgraph constituted by the stateful nodes and downstream nodes of the stateful nodes, and on each side of the partitioned edge, a data sending node is added to the data worker subgraph and a data receiving node is added to the training worker subgraph, respectively.

In an implementation, the method further includes: when a mismatch is generated between data generation of the data worker subgraph and data consumption of the training worker subgraph, performing at least one of the following operations: allocating more CPU cores to the data worker unit; and requesting for allocating a new data worker unit for the current machine learning task.

According to a third aspect of the present disclosure, a platform for computational optimization of machine learning is provided, including: a compilation server, configured to partition, through a partitioned edge, a computation graph of a received machine learning task into a data worker subgraph and a training worker subgraph, where the data worker subgraph is constituted by upstream nodes of the stateful nodes, the training worker subgraph is constituted by the stateful nodes and downstream nodes of the stateful nodes, and on each side of the partitioned edge, a data sending node is added to the data worker subgraph and a data receiving node is added to the training worker subgraph, respectively; a computation server, configured to provide a computation service for the received machine learning task, and including: a plurality of data worker units with each executing a data worker subgraph, and a plurality of training worker units with each executing a training worker subgraph, where the data worker subgraph and the training worker subgraph from a same computation graph are asynchronously executed; and a scheduling server, configured to receive a request for adding a new data worker unit for a machine learning task, and allocate a new data worker unit for a specific machine learning task based on a mismatch indicator of data worker units over training worker units for different machine learning tasks.

According to a fourth aspect of the present disclosure, a computing device is provided, including: a processor; and a memory storing executable codes which, when executed by the processor, cause the processor to perform the method described above in the first aspect or the second aspect.

According to a fifth aspect of the present disclosure, a non-transitory machine-readable storage medium, storing executable codes which, when executed by a processor of an electronic device, cause the processor to perform the method described above in the first aspect or the second aspect.

Therefore, data processing and training of deep learning tasks are decoupled by abstracting data worker (DW) and training worker (TW) parts, where the DW is responsible for reading and pre-processing original training data, and the TW uses the data pre-processed by the DW to perform gradient computing and model updating. Such design allows for dynamically adjusting the number of DWs and the resources used by each DW, so that it can meet different requirements on CPU resources from different deep learning tasks. The above-described scheme of the present disclosure is particularly suitable for application at a cluster level, through reasonable scheduling of the CPU resources across the whole cluster by a scheduler, the supply flexibility of the CPU resources for data processing will be greatly improved with no impact towards running of a training subgraph on a GPU side, thereby improving the overall processing efficiency of deep learning tasks on the platform.

### BRIEF DESCRIPTION OF DRAWINGS

The aforementioned and other objectives, features and advantages of the present disclosure will become more evident with detailed description of exemplary embodiments of the present disclosure in conjunction with the accompanying drawings, where the same reference numerals generally represent the same parts in exemplary implementations of the present disclosure.

FIG. 1 shows a schematic flowchart of a method for computational optimization of machine learning according to an embodiment of the present disclosure.

FIG. 2 shows an example of division of a computation graph based on an embodiment of the present disclosure.

FIG. 3 shows an example of implementing data communication that supports dynamic scaling by inserting communication operators after graph division.

FIG. 4 shows a system architecture diagram of a scheme for computational optimization of machine learning according to the present disclosure.

FIG. 5 shows a scheduling method for a data pipeline according to the present disclosure.

FIG. 6 shows a schematic diagram of composition of a platform for computational optimization of machine learning according to an embodiment of the present disclosure.

FIG. 7 shows a schematic structural diagram of a computing device applicable to implement the forgoing method for computational optimization of machine learning according to an embodiment of the present disclosure.

### DESCRIPTION OF EMBODIMENTS

Detailed description will be made hereunder to preferred implementations of the present disclosure, with reference to the drawings. Although the preferred embodiments of the present disclosure are illustrated in the drawings, it should be understood that the present disclosure can be implemented in various forms and should not be limited by the embodiments set forth herein. Rather, these embodiments are provided in order to make the present disclosure more thorough and complete, and to enable the scope of the present disclosure to be communicated in its entirety to those skilled in the art.

Deep learning has developed rapidly in recent years, which has achieved favorable application results in fields such as image classification, detection, video and speech processing and is still tremendously promising. Neural networks are the core of deep learning applications, and a deep learning neural network algorithm is one of the most common neural network models. The neural networks are characterized by computational and data-intensive workloads. Multiply-add operations required for neural network computations are generally on the order of Gigabytes, and parameters required for the computations are generally on the order of Megabytes to hundreds of Megabytes, etc.

A specific algorithm of a neural network can be implemented based on a deep learning computation framework. The deep learning computation framework refers to an end-to-end platform for deep learning tasks. Various deep learning frameworks often have respective ecosystems, which contain therein various tools, libraries and other resources enabling developers to easily build and deploy applications powered by deep learning. The deep learning frameworks provide construction modules for designing, training and validation of the neural networks through high-level programming interfaces.

In an actual implementation, since the neural networks are characterized by a huge parameter scale, a vast quantity of computations and extremely high parallelism, and requirements are imposed on the hardware platform for its stability and high computational energy consumption ratio, conventional CPUs can no longer meet computation requirements of the neural networks. For this reason, deep computing accelerators implemented with use of heterogeneous processors such as FPGAs, GPUs or ASICs have become a necessary choice in the field. For example, an existing deep learning-specific GPU can already be configured with up to several thousand computing cores and enables powerful parallel multiply-add computation with highly optimized scheduling.

However, the advent of these heterogeneous processors does not completely eliminate the need for general-purpose computing units (that is, CPUs) in deep learning tasks. The reason is that a deep learning dataset needs to go through a series of operations before it can be transformed into a form that can be understood by the deep learning model. These transformation operations are not suitable for being performed by the heterogeneous processors such as the GPUs described above, but are typically performed by general-purpose computing units. In the present disclosure, a “data pipeline for deep learning tasks” is used to refer to a series of operations for a deep learning dataset, the output of which will be directly used for training and inference of a deep learning model. These operations typically include, but are not limited to, data preparation and data pre-processing, and subsequent model training or inference will be driven by transforming data into a form that can be understood and used by the deep learning model.

In the existing field of deep learning, there are various types of deep learning tasks. Since the amount of pre-processing operations intensive to the CPUs varies significantly in the model, these deep learning tasks have different requirements for CPU resources. For example, for CPUs and GPUs with relatively fixed processing capacities, the CPU-to-GPU ratio required can range from 2 to 64. This means that running multiple WDL or DeepFM tasks on an 8-GPU machine will require at least 512 CPU cores to keep up with the data consumption speed of the GPUs. However, running Bert tasks on the same 8-GPU machine requires only 16 CPU cores. Since it is often impossible to determine the type of deep learning tasks to run on a particular machine, hardware inefficiency can be caused by a ratio mismatch between CPUs and GPUs, regardless of whether more or fewer CPUs are equipped.

To this end, the present disclosure proposes a scheme for decoupling data processing and training parts of deep learning tasks by abstracting a Data Worker (DW, that is, data worker machine/unit) and a Training Worker (TW, that is, training worker machine/unit), where the Data Worker is responsible for reading and pre-processing original training data, and the Training Worker uses the data pre-processed by the Data Worker to perform gradient computing and model updating. Such design allows for dynamically adjusting the number of Data Workers and the resources used by each Data Worker, so that it can meet different requirements on CPU resources from different deep learning tasks. The above-described scheme of the present disclosure is particularly suitable for application at a cluster level, through reasonable scheduling and usage of the CPU resources across the whole cluster by a scheduler, the supply flexibility of the CPU resources for a Data Worker will be greatly improved with no impact towards running of a Training Worker on a GPU side, thereby improving the overall processing efficiency of deep learning tasks on the platform.

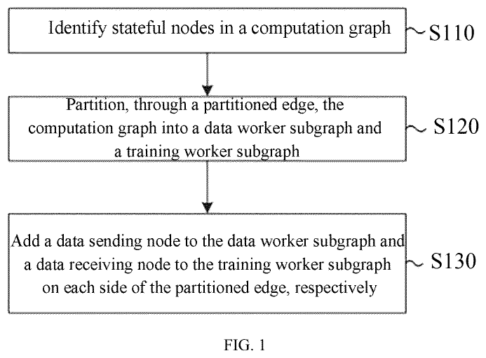

FIG. 1 shows a schematic flowchart of a method for computational optimization of machine learning according to an embodiment of the present disclosure. The method is directed at division of a computation graph, which can be regarded as content executed by a machine learning compiler. At the level of a single task, a user can submit a deep learning task without any modification to original codes, for example, handing over for local standalone operation, or handing over to a deep learning training platform arranged on the cloud for operation. For a given segment of deep learning codes, the present scheme can use a graph decoupler to identify and decouple a data pre-processing part from a computation graph, and distribute same to a Data Worker for running. The Data Worker may transmit pre-processed data to a Training Worker through communications for subsequent training. In an embodiment, the graph decoupler can be regarded as an additional component added to the compiler of the deep learning framework according to the present disclosure. After the compiler generates the computation graph from the codes submitted by the user, a decoupling operation on data processing and training for the computation graph may be performed by the graph decoupler according to the present disclosure.

At step S110, identify stateful nodes in a machine learning computation graph. Here, the “stateful” nodes belong to a concept relative to “stateless” nodes. The stateful nodes are nodes that might change with training iterations at runtime, that is, nodes for maintaining model parameters, and these nodes will come up with state changes due to backward propagation based on a loss function during training. In contrast, the stateless nodes do not involve state changes during training.

After the stateful nodes are identified, at step S120, it is possible to partition, through a partitioned edge, the machine learning computation graph into a data worker (DW) subgraph constituted by upstream nodes of the stateful nodes and a training worker (TW) subgraph constituted by the stateful nodes and downstream nodes of the stateful nodes. In other words, as long as a node is located upstream of all stateful nodes, it means that the node will not come up with a state change due to practical training, and thus can be executed asynchronously without waiting for a state update.

After the two subgraphs used for data processing and training are divided, in order to ensure correct data communication during subsequent asynchronous execution, also at step S130, it is possible to add a data sending node (DWSend) to the data worker subgraph and a data receiving node (DWRecv) to the training worker subgraph on both sides of a partitioned edge.

Here, the data sending node and the data receiving node can be collectively referred to as a “communication node”. It should be understood that each node in the computation graph corresponds to a particular operator (op), and an edge between nodes corresponds to flowing of data, therefore, through adding “communication nodes” to each side of the partitioned edge, it can be ensured that data flows correctly along a path indicated by an original edge during asynchronous execution for DW and TW.

Thus, by dividing a computation graph in a compiling stage on the basis of whether a node is stateful or stateless and adding communication nodes at the division part, data processing and training parts of a same deep learning task are enable to be decoupled, thereby a premise basis is provided for dynamic allocation of general-purpose computational resources subsequently used for data processing.

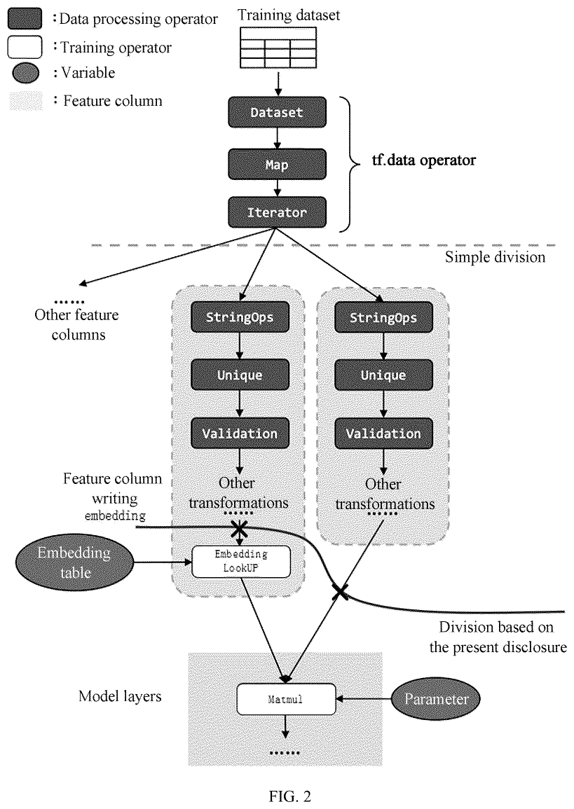

Hereinafter, a specific example is used in conjunction with FIG. 2 to illustrate how to automatically identify a maximal range separable for execution on a Data Worker side from an original dataflow graph according to the graph partitioning strategy of the present disclosure. FIG. 2 shows an example of division of a computation graph based on an embodiment of the present disclosure.

Since the deep learning framework TensorFlow provides a tf.data.service library, a user can manually reconstruct codes based on an existing tf.data operator, thereby implementing acceleration of the pre-processing part to some extent. A training dataset may be preliminarily processed via tf.data operators of a Dataset, a Map and an Iterator in the computation graph, and as shown in the drawing, the computation graph may be simply divided based on identities of the tf.data operators. However, the above-mentioned partitioned range obviously falls short of optimization, the reason is that non-tf.data operators (stringOps (string operator), Unique and Validation operators as shown in the drawing) are actually also operators which are asynchronously executed by the CPU and used for data pre-processing.

To this end, the present disclosure defines a subgraph of the data pre-processing part from the perspective of a computation graph, that is, the nodes in the subgraph do not undergo backward propagation. If the nodes need backward propagation, then in each training step, the nodes should wait for completion of parameter updating in backward computation before coming to processing at a next step, and cannot asynchronously enter the next step in advance. From the perspective of a data flow graph, the attribute without backward computation may be interpreted as the nodes being independent of stateful nodes (that is, nodes for maintaining model parameters), the reason is that asynchronous execution is possible without waiting for state updating as long as one node is located upstream of all stateful nodes.

Thus, with the criteria of division on the basis of whether a node is stateful or stateless, the stringOps (string operator), the Unique and the Validation operators as shown in the drawing as well as other operators related to data transformations (e.g., graphic transformations) can also be divided into the DW subgraph of the present disclosure. Only when advancing to the illustrated feature column on the left and involving reading an Embedding Lookup node of an Embedding table, the first stateful node will be encountered due to embedded reading related to the feature column. At this point, the partition (as shown by a sign x on the left of FIG. 2) can be performed on the input side (namely, the upper part) of the Embedding Lookup node based on the partitioning criteria specified in step S120.

Similarly, the operator related to the illustrated feature column on the right only relates to data pre-processing, and since the backbone-incorporated Matmul (multiply-add) operator needs to perform an embedded read-write operation related to the feature column, the partition (as shown by a sign x on the right of FIG. 2) can be performed on an connected edge between the feature column on the right and the backbone operator, i.e., the Matmul operator, based on the partitioning criteria specified in step S120. Similar operations may be performed on other feature columns, thereby achieving the division based on the present disclosure.

In practical operations, an optimized graph division algorithm may be used to perform computation graph division. In an embodiment, step S120 may include: starting from all the stateful nodes in the computation graph for performing model parameter updating, searching for all the downstream nodes, to obtain a set of nodes and an edge thereof that constitute the training worker subgraph; and performing a search from a source node, to obtain a set of nodes excluding the nodes of the training worker subgraph, and obtaining the data worker subgraph. In particular, firstly, starting from a stateful node, all downstream nodes may be found through a breadth-first search, and the obtained set of nodes and the edge(s) thereof constitute the Training Worker subgraph. Then, another breadth-first search is performed from the source node, to obtain a set of nodes excluding the nodes of the Training Worker subgraph and constitute the Data Worker subgraph.

As previously mentioned, after the DW and TW subgraphs are divided, a pair of communication nodes can also be added on both sides of each partitioned edge. Taking the computation graph shown in FIG. 2 as an example, a DWSend node can be added above the sign x on the left (that is, after other transformations on the left) and a DWRecv node can be added below the sign x on the left (that is, atop the Embedding Lookup node). Similarly, a DWSend node can be added above the sign x on the right (that is, after other transformations on the right) and a DWRecv node can be added below the sign x on the right (that is, atop the Matmul node).

Therefore, in the divided DW, the processed data obtained from other transformations in the feature column on the left can be finally sent by the DWSend node and received by the corresponding DWRecv node on the left in the divided TW. Similarly, the processed data obtained from other transformations in the feature column on the right can be finally sent by the DWSend node on the right and received by the corresponding DWRecv node on the right in the divided TW.

In addition, although not shown in FIG. 2, it should be understood that there can be a case where multiple DWSend nodes or DWRecv nodes are connected to a same node of the computation graph, which corresponds to a case where multiple edges connected to the node are partitioned simultaneously. In other words, the computation graph is partitioned against edges, and the DWSend node and the DWRecv node on each side of each partitioned edge can be regarded as a data transfer path between the data worker subgraph and the training worker subgraph that are asynchronously executed.

After dividing the DW subgraph and the TW subgraph and adding communication nodes, the asynchronous execution between the DW and TW subgraphs can be implemented. Accordingly, the optimization method of the present disclosure further includes: asynchronously executing the data worker subgraph and the training worker subgraph. Here, the “asynchronously executing” means that the DW subgraph and the TW subgraph can be executed without being classified into a same pipeline. In the present disclosure, different hardware resources (especially different types of hardware resources) can be used to implement execution of the DW subgraph and the TW subgraph in different processes. In an embodiment, a Data Worker (data worker unit) can be used to execute the DW subgraph and a Training Worker can be used to execute the TW subgraph. The data worker unit uses the CPU to perform various data preparation and pre-processing operations involved in the DW subgraph. The training worker unit can mainly use a heterogeneous processor, such as a GPU dedicated to deep learning, to perform neural network training operations involved in the TW subgraph. However, it should be understood that the execution of the TW subgraph also involves some CPU operations, such as scheduling operations, but the above-mentioned scheduling operations generally neither constitute efficiency bottlenecks and nor are a main part of operations of the TW subgraph.

With the improvement of the processing capacity of the heterogeneous processor, the efficiency problem faced by deep learning tasks at the present stage has gradually shifted from computing bottlenecks to data bottlenecks. Under this circumstance, the asynchronous execution implemented by decoupling data pre-processing and training operations according to the present disclosure is particularly suitable for solving the problem of inefficient overall execution of tasks caused by insufficient data pre-processing capacity. To this end, in an embodiment, asynchronously executing the data worker subgraph and the training worker subgraph may include: dynamically scaling, based on a mismatch indicator between data generation of the data worker subgraph and data consumption of the training worker subgraph, an amount of CPU resources for execution of the data worker subgraph. Here, the “dynamically scaling” refers to a technique for automatically adjusting the computational processing capacity according to computational power requirements of tasks. With this technique, the computational resources used by the tasks will be adjusted at runtime based on the load. Sufficient computational power will be provided while saving resource costs as many as possible.

Since the DW subgraph and the TW subgraph are executed by different hardware resources in different processes, there may be a mismatch between the speed at which the processed data is generated by executing the DW subgraph and the speed at which the processed data is consumed by executing the TW subgraph for training. For example, an existing CPU can pre-process an amount of A data per unit time, while an existing heterogeneous processor (for example, a GPU) can process pre-processed data corresponding to an amount of 4A per unit time. In other words, the processed data generated through the processing capacity of the existing CPU cannot “feed up” the GPU, resulting in low GPU utilization and consequent waste due to mismatch of the processing capacity.

To this end, when the processing speed of a heterogeneous processor (for example, a GPU) executing the TW subgraph is used as a judge criterion, the amount of CPU resources for execution of the data worker subgraph can be dynamically scaled according to a mismatch indicator. Under different circumstances, dynamically scaling the amount of CPU resources for execution of the data worker subgraph may include different implementations. For example, when the mismatch indicator indicates a mismatch (that is, when the processed data generated by an existing Data Worker cannot feed up the Training Worker), the number of CPU cores participating in execution of the data worker subgraph can be increased. In other words, the CPU resources allocable by the current data worker can be increased (for example, allocating more CPU cores to a current Data Worker process locally), thereby improving the data generation efficiency of the current Data Worker. As a replacement or a supplement, when the mismatch indicator indicates a mismatch, a new CPU resource for independent execution of the data worker subgraph can also be requested. In other words, the number of Data Workers performing the current task can be increased. Accordingly, after the new CPU resource is allocated (and after a corresponding thread of the new Data Worker is generated therefrom), the new Data Worker can replicate the data worker subgraph, select data from a training dataset for processing (different from the data selected by the existing CPU resources for execution of the data worker subgraph), and send the processed data to the same data receiving node. In other words, there may be one Training Worker for the same task, but multiple Data Workers may be provided based on data consumption requirements of the Training Worker. The multiple Data Workers work independently, but provide processed data to DWRecv operators of the same Training Worker.

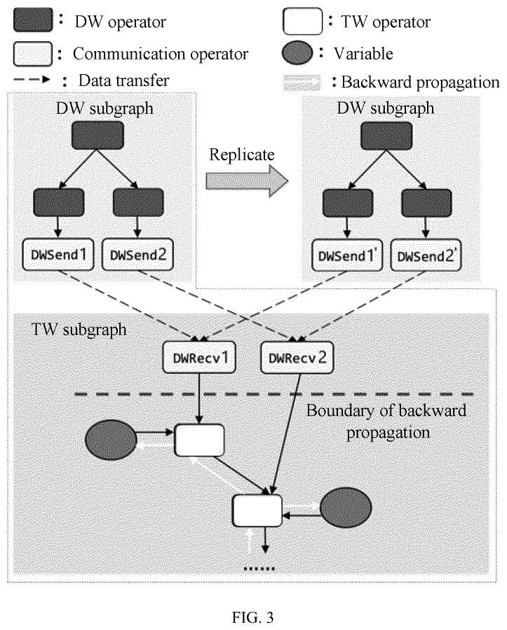

FIG. 3 shows an example of implementing data communication that supports dynamic scaling by inserting communication operators after graph division. As shown in the drawing, it can be assumed that when a task is actually executed, by default, it uses a configuration as shown in the dotted box where one Data Worker executes one DW subgraph and one Training Worker executes one TW subgraph. At this point, since two edges are partitioned during subgraph division, there are two pairs of communication operators, that is, DWSend1 and DWRecv1, as well as DWSend2 and DWRecv2.

After the running starts, if it is found that the data consumption speed of the DWRecv1 and the DWRecv2 is greater than the data sending speed of the DWSend1 and the DWSend2 (that is, DWRecv1 and DWRecv2 are always in a data waiting state), a new Data Worker can be assigned to the current task. At this point, as shown by the replication arrow in the drawing, the new Data Worker can directly replicate a new DW subgraph (including data sending nodes of the DWSend1 and the DWSend2). However, in the TW subgraph part, the DWRecv1 and the DWRecv2 remain unchanged at this point. Thus, the DWRecv1 can receive processed data from the DWSend1 and the DWSend1′, and the DWRecv2 can receive processed data from the DWSend2 and the DWSend2′. When the new Data Worker has the same data processing capacity as that of the original Data Worker, the addition of the new Data Worker can double the data production capacity of the DW subgraph, thereby improving the mismatch problem.

Since only one DWRecv node is provided for each partitioned edge in the TW subgraph, and since the DW subgraph and the TW subgraph are executed asynchronously, it is preferable to create a queue for each DWRecv node to store data from one or more corresponding DWSend nodes. In an implementation, a queue state of the queue can also be used as a performance indicator for monitoring, and the indicator can indicate an execution mismatch between the current DW subgraph and the TW subgraph. In an embodiment, the state of the queue can be treated as the mismatch indicator as described above.

To this end, asynchronously executing the data worker subgraph and the training worker subgraph includes: acquiring, by a data worker unit, a first predetermined amount of training data, and performing a pre-processing operation based on the data worker subgraph; sending pre-processed data from the data sending node to a pre-processing result storage queue; acquiring, by the data receiving node, the pre-processed data from the pre-processing result storage queue; and according to the pre-processed data, performing, by a training worker unit, a training operation based on the training worker subgraph.

Correspondingly, sending the pre-processed data from the data sending node to the pre-processing result storage queue includes: maintaining, by a data receiving operator corresponding to the data receiving node, the pre-processing result storage queue, and continuously pulling the pre-processed data from the data sending node to the pre-processing result storage queue.

The data receiving node pulls a second predetermined amount of the pre-processed data from the pre-processing result storage queue each time and distributes a new index of the first predetermined amount of training data to the data worker unit. In an embodiment, the first predetermined amount of training data processed by the DW each time may correspond exactly to the second predetermined amount for the TW to pull each time (since the amount of data may change during pre-processing). In an implementation, the second predetermined amount may be an amount of training required by the TW to perform a training step of the neural network.

In other words, after decoupling the original data flow diagram, different subgraphs can be executed concurrently between a Training Worker and one and more Data Workers in the present disclosure. In order to achieve horizontal scalability and resource resiliency, different Data Workers use data parallelly for execution, that is, the first predetermined amount of training data acquired by each Data Worker each time can produce exactly a whole mini-batch of data required by a Training Worker for a training step (run). In an implementation, the same mini-batch of data is not partitioned across multiple Data Workers, to avoid repetitive and inefficient executions such as unique and validation operations. Meanwhile, the present disclosure can adopt a dynamic data distribution mechanism, that is, the system continuously distributes source data indexes (such as file names) required for the mini-batch of data to the Data Worker, thereby avoiding the re-partitioning of the data when the Data Worker performs dynamical scaling. In an implementation, a data queue can be implemented by a DWRecv operator on a Training Worker side, and the operator continuously calls a DWSend operator on a Data Worker side in the background and pulls data into the queue. In each execution of the computation graph of the Training Worker, the Training Worker will extract a mini-batch of data from the queue and simultaneously trigger a next distribution of a data index for the Data Worker.

Accordingly, the present disclosure can also be implemented as a method for computational optimization of machine learning. Since a DW and a TW for a same task are preferably implemented on one physical device (such as a computation server), the method can be regarded as a method performed by a physical device for execution of a computation graph. The method includes: acquiring, by a data worker unit performing computation based on a CPU, a first predetermined amount of training data and performing a pre-processing operation based on a data worker subgraph, and sending pre-processed data via a data sending node; acquiring, by a training worker unit performing deep learning computation based on a heterogeneous processing unit (for example, a GPU), the pre-processed data via a data receiving node to perform a training operation based on the training worker subgraph, where in a compiling stage, a computation graph of a current machine learning task is partitioned, through a partitioned edge, into the data worker subgraph constituted by upstream nodes of the stateful nodes and the training worker subgraph constituted by the stateful nodes and downstream nodes of the stateful nodes, and on each side of the partitioned edge, a data sending node is added to the data worker subgraph and a data receiving node is added to the training worker subgraph, respectively. The above-described compilation for deep learning tasks can be implemented in a same physical device where a DW and a TW is implemented, or can be implemented by different physical devices.

Furthermore, the method may further include: when a mismatch is generated between data generation of the data worker subgraph and data consumption of the training worker subgraph, performing at least one of the following operations: allocating more CPU cores to the data worker unit; and requesting for allocating a new data worker unit for the current machine learning task.

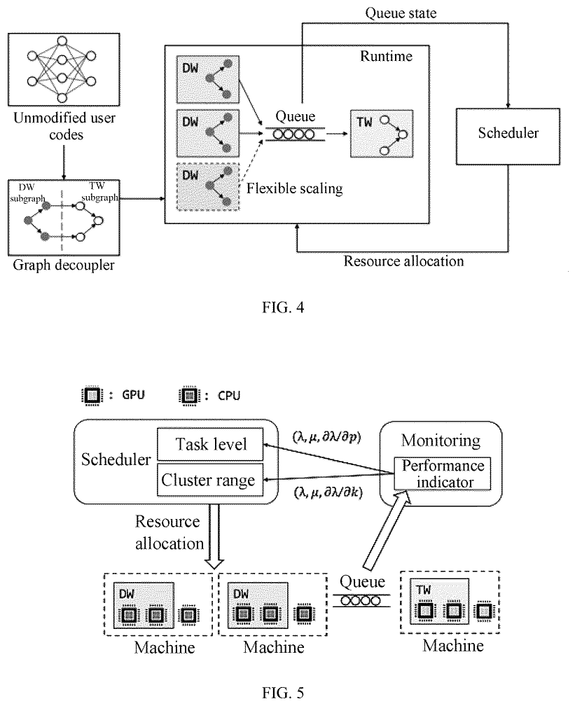

FIG. 4 shows a system architecture diagram of a scheme for computational optimization of machine learning according to the present disclosure. First, the system may receive unmodified user codes and, in a compiling stage, partition a computation graph into DW and TW subgraphs via a graph decoupler. Then, in a running stage, a scheduler may perform resource allocation according to a queue state, to achieve flexible scaling for a DW. For example, in case of insufficient data pre-processing capacity, more DWs are provided; whereas when the data processing capacity of the DWs exceeds the data consumption capacity of the TW, an existing DW can be deactivated.

The system shown in FIG. 4 may be implemented by a single machine, for example, by a single physical device equipped with both a multicore CPU and a deep learning dedicated GPU. In case of the implementation by the single machine, the scheduler may be a local resource scheduler. The single machine may implement a DW thread and a TW thread during computation when executing compiled codes (at this point, the computation graph has been divided into DW and TW subgraphs), and select to increase the number of CPU cores of a current DW or to add a DW thread when it is determined, based on a queue state, that the data production speed of the DW thread is insufficient.

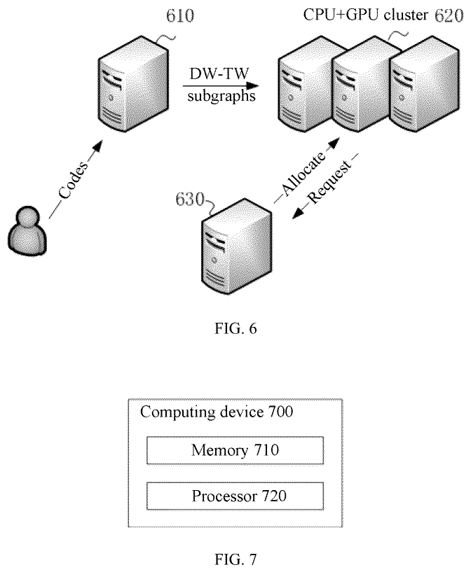

In an embodiment, the system shown in FIG. 4 may be implemented by a cloud platform that provides deep learning computation services. The platform may be equipped with, for example, a dedicated GPU cluster, and meanwhile provide computation services for deep learning tasks related to different users (for example, various types of tenants). In conjunction with FIG. 5 and FIG. 6, detailed descriptions will be given hereunder to application at a cluster level according to the present disclosure.

With the wide application of deep learning algorithms in numerous fields, the scale of deep learning tasks and the scale of clusters supporting the deep learning tasks gradually increase. Therefore, large cloud service providers generally build large-scale multi-tenant heterogeneous processor clusters and construct large-scale machine learning platforms therein, to support a large number of deep learning applications. Among numerous heterogeneous processors, GPUs become a mainstream of deep learning specific processors due to their more excellent performance. Since GPU cards are not economical in terms of hardware, these large-scale deep learning clusters are generally constructed in a multi-tenant form, and a large number of users share GPU computation resources simultaneously.

Nowadays, the industry mainly uses large-scale GPU clusters to perform deep learning training. In order to improve the utilization of the clusters and the performance of training tasks, the focus in the existing work is mainly on scheduling and computational acceleration of the deep learning tasks. However, with the rapid growth of the scale of training data and the improvement of computing efficiency of deep learning models, training for the deep learning tasks in the large-scale clusters has gradually shifted from computation bottlenecks to data bottlenecks. Through detailed measurement and analysis on data pipelines of massive practical deep learning production tasks, the inventors find a series of tasks showing data reading and data pre-processing bottlenecks, which may cause significant degradation of the performance of the deep learning tasks and further cause low utilization of critical computational resources (for example, GPUs), resulting in an enormous waste of resources.

Currently, for a deep learning task, a data pipeline is bound with a training process and they run in a same machine. However, since ratios of CPU resources to GPU resources required by different deep learning tasks vary significantly, such versatility leads to the ratio of hardware resources of numerous machines being unable to meet task requirements, which eventually results in resource fragmentation to greatly reduce the running efficiency of the deep learning tasks, and which affects the utilization of cluster hardware resources and causes a waste of resources. Therefore, it is urgent to propose a dynamic scalable scheduling method for a data pipeline of a deep learning task, so that the computation for the data pipeline of the deep learning task can break machine limits to improve the running efficiency of the deep learning task, and enhance the utilization of CPU and GPU resources.

Further, data pipelines in an existing deep learning framework are driven by data pre-fetching of respective deep learning training tasks, but fail to globally and dynamically plan allocation of CPU resources, thereby being unable to maximize the efficiency of bandwidth utilization. Therefore, a policy capable of allocating CPU resources dynamically and reasonably among deep learning tasks is urgently needed, so that the tasks run at ideal performance (that is, the performance that is not blocked by data pre-processing) to the greatest extent, thereby improving effective utilization of cluster CPU and GPU resources.

To this end, through a coordinated design of a cluster scheduler and a deep learning computation framework, the present disclosure renders an automatic dynamic scalable scheduling system for a data pipeline of a deep learning task. The present scheme re-optimizes deep learning training from the perspective of the data pipeline, to more advantageously utilize the provided resources, and accelerate the data pipeline of the deep learning task. Due to the application of the automatic dynamic scalable scheme, the data pre-processing time of the deep learning task is significantly reduced, and the task running efficiency is greatly improved.

FIG. 5 shows a scheduling method for a data pipeline according to the present disclosure. The system performs the scheduling at two levels: the system explores a most suitable resource configuration for a task at each task level, at the same time, continuously adjusts resource allocation among tasks within a cluster range to achieve a global scheduling goal. This process is driven by a uniform performance indicator. An obvious choice of the performance indicator is a data queue state. If a Data Worker and a Training Worker performing a same task are treated as a producer-consumer model, the execution rate of the overall pipeline is determined by the slower side. Therefore, at any time, production and consumption speeds on two sides and a speed difference therebetween can be acquired by monitoring data enqueuing and dequeuing rates of a data queue on the Training Worker, and the possible performance enhancement room when the Data Worker acquires more resources can be estimated accordingly.

As shown in FIG. 5, resource adjustment for the Data Worker may be performed from task and cluster levels based on the following parameters.

Here, μ can be represented as the throughput of pulling data from a queue and using data for task i; λ is represented as the throughput of producing data and pushing data into a queue in a data pipeline corresponding to task i. Here, μ can be determined by GPU and CPU resources used by a TW, and λ can be determined by CPU resources per DW (that is, parallelism p) and by the number k of DWs used. At the task level, if it is determined, based on variations of u and 2, that an insufficient production rate exists for a DW, improvement in the processing capacity of the DW can be achieved by increasing the parallelism (∂λ/∂p). At the cluster level, if it is determined, based on variations of u and 2, that insufficient production rates exist for DWs, the improvement of the processing capacity of the DWs can be achieved by adding a new DW (∂λ/∂k).

In an embodiment, the system completes the scheduling work at the above two levels through three steps: (1) adjusting CPU resources of each Data Worker, that is, searching for a maximum of CPUs, so that the Data Worker keeps linear scalability inside a single process, thereby achieving a balance between overhead and scalability. The system initially allocates, for each Training Worker, one Data Worker that uses one CPU core; in an implementation, the initial Data Worker and the Training Worker may be located on a same physical device (at this point, the GPU can be regarded as a co-processor of the CPU), or may be physically close to each other. Then, the system adjusts the number of CPUs of the Data Worker by using the following method: if the queue has reached an ideal state, that is, the Data Worker is as fast as the Training Worker, then not increasing the number of CPU resources; if the DW starts to present a sub-linear acceleration, or the CPU resources on the current machine have been consumed, then selecting a highest amount of CPUs capable of implementing linear acceleration as maximum resources for usage by each Data Worker. (2) Adjusting the number of Data Workers for the task. If a single Data Worker is insufficient to meet task requirements, the task applies to the scheduler for more Data Workers, and estimates corresponding performance enhancement according to a current queue state at the time of applying. The scheduler may select a task with the highest performance enhancement from all tasks at a time and assign an additional Data Worker to it. This process is repeated till there is no performance enhancement or the CPU resources in the cluster are consumed. In addition, the scheduler can preferably attempt to place the DW in a more TW-friendly location, for example, the local machine of the TW, to reduce network communications. (3) Adjusting the CPU resources of the Training Worker: besides dedicated GPUs, the execution of the TW subgraph will also require CPUs to perform some general operations, and when a task finds that its data queue has already been in an ideal state, it will attempt to allocate less CPUs for the TW till it finds a minimal value to maintain this ideal state.

To this end, the present disclosure can also be implemented as a platform for computational optimization of machine learning. FIG. 6 shows a schematic diagram of composition of a platform for computational optimization of machine learning according to an embodiment of the present disclosure. As shown in FIG. 6, the platform 600 may include: a compilation server 610, a computation server 620 and a scheduling server 630.

The compilation server 610 may acquire deep learning task codes submitted by a user and compile the codes; and further, partition, through a partitioned edge, a computation graph of a complied machine learning task into a data worker subgraph and a training worker subgraph, where the data worker subgraph is constituted by upstream nodes of the stateful nodes, the training worker subgraph is constituted by the stateful nodes and downstream nodes of the stateful nodes, and on each side of the partitioned edge, a data sending node is added to the data worker subgraph and a data receiving node is added to the training worker subgraph, respectively.

The computation server 620 may include a large number of general-purpose and dedicated computational resources, such as CPU clusters and GPU clusters, and is configured to provide a computation service for the received machine learning task, and including: a plurality of data worker units with each executing a data worker subgraph, and a plurality of training worker units with each executing a training worker subgraph, where the data worker subgraph and the training worker subgraph from a same computation graph are asynchronously executed. In some embodiments, the computation server 620 may also directly acquire user codes and perform compilation, that is, the computation server itself may contain the functions of the compilation server.

The scheduling server 630 can be configured to receive a request for adding a new data worker unit for a machine learning task, and allocate a new data worker unit for a specific machine learning task based on a mismatch indicator of data worker units over training worker units for different machine learning tasks (for example, in the above, the corresponding performance improvement estimated based on a current queue state for a task).

FIG. 7 shows a schematic structural diagram of a computing device applicable to implement the forgoing method for computational optimization of machine learning according to an embodiment of the present disclosure.

With reference to FIG. 7, a computing device 700 includes a memory 710 and a processor 720.

The processor 720 may be a multi-core processor or may contain multiple processors. In some embodiments, the processor 720 may contain a common primary processor and one or more special co-processors, such as a graphics processing unit (GPU), an application specific integrated circuit (ASIC), or a field programmable gate array (FPGA). These co-processors can be heterogeneous processors with parallelism that are dedicated to deep learning computation.

The memory 710 can include various types of storage units, such as system memories, read-only memories (ROM), and permanent storage devices. Among them, the ROM can store static data or instructions required by the processor 720 or other modules of the computer. The permanent storage device can be a read-write storage device. The permanent storage device can be a non-volatile storage device that will not lose stored instructions and data even after a computer is powered off. In some embodiments, the permanent storage device uses a mass storage device (for example, a magnetic or optical disk, or a flash memory) as a permanent storage device. In other embodiments, the permanent storage device can be a removable storage device (for example, a floppy disk, or an optical disk drive). The system memory can be a read-write storage device or a volatile read-write storage device, such as a dynamic random access memory. The system memory can store some or all of the instructions and data that the processor needs at runtime. In addition, the memory 710 can include any combination of computer-readable storage media, including various types of semiconductor memory chips (a DRAM, an SRAM, an SDRAM, a flash and a programmable read-only memory), disks and/or optical disks. In some embodiments, the memory 710 may include removable storage devices that are readable and/or writable, such as laser discs (CD), read-only digital multifunction discs (such as DVD-ROMs, dual-layer DVD-ROMs), read-only Blu-ray discs, super-density discs, flash memory cards (such as SD cards, mini SD cards, Micro-SD cards, etc.), magnetic floppy disks, or the like. The computer-readable storage medium does not contain carriers and instantaneous electronic signals transmitted in a wireless or wired way.

Executable codes are stored in the memory 710, and when the executable codes are processed by the processor 720, the processor 720 is enabled to perform the foregoing method for computational optimization of machine learning.

The scheme for computational optimization of machine learning according to the present disclosure has been described above in detail with reference to the accompanying drawings.

The present scheme is independent of the partitioning and placement manually by users for computations. The users do not need to modify their own codes, and the system can automatically identify, from its data flow diagram, the part that can be offloaded to the Data Worker for asynchronous execution; during running, the system can start the Data Worker by itself, and acquire the data flow diagram (DW subgraph) that it needs to execute, to complete the data exchange between the TW and the DW. The entire process is automated and fully transparent to the users.

According to the present scheme, a data flow graph is automatically partitioned on the basis of whether the nodes of the graph have a backward computation rule, whereby a maximum range of a data pipeline in the computation graph can be found, thereby maximizing the gains brought by computational partitioning. As shown in FIG. 2, in a common recommendation model, if a method similar to tf.data.service is used to perform the partitioning, only some I/O operations encapsulated in these APIs (the simple division in the drawing) can be partitioned. However, practically, in addition to this part of computation, there are still some computations which are not backward and where the partitioning is possible, but these computations cannot be encapsulated into tf.data.service due to API reasons. The graph partitioning algorithm in the present scheme can automatically extend the partitioning range to such operators to improve partitioning gains.

The present scheme takes the lead in designing a data communication operator that supports dynamic scaling and a runtime scaling mechanism, so that Data Workers can be scaled dynamically and transparently without affecting training and computing, thereby fully improving resource utilization efficiency.

Furthermore, the present scheme enables two levels of a deep learning framework and cluster scheduling to cooperate. Specifically, the present scheme proposes to use a data queue state between a Data Worker and a Training Worker as a performance indicator to guide the system to dynamically adjust resource allocation at task and cluster levels for improved cluster efficiency.

Therefore, the present disclosure proposes an automatic computational decoupling method, according to which a data flow diagram of an original deep learning model can be automatically partitioned into two parts, i.e., a Data Worker and a Training Worker, and a computation range with the partitioning being possible is maximized by searching a part of the original graph without backward computation, thereby improving the gains of computational partitioning.

The present scheme further proposes a dynamically scalable Data Worker execution mechanism, which implements data transmission and reception among multiple Data Workers by introducing data communication operators that support dynamic scaling, and which meanwhile enables the Data Workers to transparently scale at runtime to improve resource utilization efficiency.

The present scheme further proposes a scheduling method for a data pipeline, which uses a producer-consumer model between a Data Worker and a Training Worker to reflect the adequacy of Data Worker resources and the possible performance enhancement room per task, and which dynamically adjusts the resource allocation at task and cluster levels according to this information, to maximize cluster efficiency.

In addition, the method according to the present disclosure can also be implemented as a computer program or a computer program product. The computer program or the computer program product includes computer program code instructions for executing each of the steps defined in the foregoing method of the present disclosure.

Alternatively, the present disclosure can also be implemented as a non-transitory machine-readable storage medium (or a computer-readable storage medium, or a machine-readable storage medium) having executable codes (or computer programs, or computer instruction codes) stored thereon, where when the executable codes (or the computer programs, or the computer instruction codes) are executed by a processor of an electronic device (or a computing device, or a server, or the like), the processor is enabled to perform each of the steps in the foregoing method of the present disclosure.

Those skilled in the art will also understand that various exemplary logic blocks, modules, circuits, and algorithm steps described in conjunction with the disclosures described herein may be implemented as electronic hardware, computer software, or a combination thereof.

The flowcharts and block diagrams in the drawings illustrate architectures, functionalities and operations of possible implementations of the system and the method according to embodiments of the present disclosure. In this regard, each block in the flowcharts or block diagrams may represent a module, a program segment or part of codes, which contains one or more executable instructions for implementing specified logical functionalities. It should also be noted that, in some alternative implementations, the functionalities marked in the blocks may also occur in a different order from that marked in the drawings. For example, two blocks shown in succession may actually be executed in parallel substantially, and sometimes they can be executed in a reverse order, depending on functionalities involved. It should also be noted that each block in the block diagrams and/or the flowcharts, and a combination of blocks in the block diagrams and/or the flowcharts, may be implemented by a dedicated hardware-based system that performs specified functionalities or operations, or may be implemented by a combination of dedicated hardware and computer instructions.

The embodiments of the present disclosure have been described above. The foregoing descriptions are exemplary rather than exhaustive, and are not limited to the embodiments disclosed. Various modifications and changes are obvious to those of ordinary skill in the art without deviating from the scope and spirit of the embodiments described. The terms used herein are selected to best explain the principles of the embodiments, practical applications, or improvements to technology in the market, or to enable others of ordinary skill in the art to understand the embodiments disclosed herein.

1. A method for computational optimization of machine learning, comprising:
identifying stateful nodes in a machine learning computation graph;
partitioning, through a partitioned edge, the machine learning computation graph into a data worker subgraph constituted by upstream nodes of the stateful nodes and a training worker subgraph constituted by the stateful nodes and downstream nodes of the stateful nodes; and
on each side of the partitioned edge, adding a data sending node to the data worker subgraph and adding a data receiving node to the training worker subgraph, respectively.

2. The method according to claim 1, further comprising:
asynchronously executing the data worker subgraph and the training worker subgraph.

3. The method according to claim 2, wherein asynchronously executing the data worker subgraph and the training worker subgraph comprises:
dynamically scaling, based on a mismatch indicator between data generation of the data worker subgraph and data consumption of the training worker subgraph, an amount of central processing unit (CPU) resources for execution of the data worker subgraph.

4. The method according to claim 3, wherein dynamically scaling the amount of CPU resources for execution of the data worker subgraph comprises at least one of:
when the mismatch indicator indicates a mismatch, increasing a number of CPU cores participating in execution of the data worker subgraph;
when the mismatch indicator indicates a mismatch, requesting for a new CPU resource for independent execution of the data worker subgraph.

5. The method according to claim 4, wherein after the new CPU resource is allocated, the data worker subgraph is replicated, training data in a training dataset is selected for processing, and processed training data is sent to the same data receiving node.

6. The method according to claim 2, wherein asynchronously executing the data worker subgraph and the training worker subgraph comprises:
acquiring, by a data worker unit, a first predetermined amount of training data, and performing a pre-processing operation based on the data worker subgraph;
sending pre-processed data from the data sending node to a pre-processing result storage queue;
acquiring, by the data receiving node, the pre-processed data from the pre-processing result storage queue; and
according to the pre-processed data, performing, by a training worker unit, a training operation based on the training worker subgraph.

7. The method according to claim 6, wherein sending the pre-processed data from the data sending node to the pre-processing result storage queue comprises:
maintaining, by a data receiving operator corresponding to the data receiving node, the pre-processing result storage queue, and continuously pulling the pre-processed data from the data sending node to the pre-processing result storage queue.

8. The method according to claim 6, wherein the data receiving node pulls a second predetermined amount of the pre-processed data from the pre-processing result storage queue each time and distributes a new index of the first predetermined amount of training data to the data worker unit.

9. The method according to claim 1, wherein partitioning, through the partitioned edge, the machine learning computation graph into the data worker subgraph constituted by the upstream nodes of the stateful nodes and the training worker subgraph constituted by the stateful nodes and the downstream nodes of the stateful nodes comprises:
starting from all the stateful nodes in the computation graph for performing model parameter updating, searching for and finding all the downstream nodes, to obtain a set of nodes and an edge of the set of the nodes that constitute the training worker subgraph;
performing a search from a source node, to obtain a set of nodes excluding the nodes of the training worker subgraph, and obtaining the data worker subgraph.

10. A method for computational optimization of machine learning, comprising:
acquiring, by a data worker unit performing computation based on a central processing unit (CPU), a first predetermined amount of training data;
performing a pre-processing operation based on a data worker subgraph;
sending pre-processed data via a data sending node; and
acquiring, by a training worker unit performing deep learning computation based on a heterogeneous processing unit, the pre-processed data via a data receiving node to perform a training operation based on a training worker subgraph,
wherein a computation graph of a current machine learning task is partitioned, through a partitioned edge, into the data worker subgraph constituted by upstream nodes of stateful nodes and the training worker subgraph constituted by the stateful nodes and downstream nodes of the stateful nodes, and on each side of the partitioned edge, a data sending node is added to the data worker subgraph, and a data receiving node is added to the training worker subgraph, respectively.

11. The method according to claim 10, further comprising:
when a mismatch is generated between data generation of the data worker subgraph and data consumption of the training worker subgraph, performing at least one of the following operations:
allocating more CPU cores to the data worker unit;
requesting for allocating a new data worker unit for the current machine learning task.

12. A platform for computational optimization of machine learning, comprising:
a compilation server, configured to partition, through a partitioned edge, a computation graph of a received machine learning task into a data worker subgraph and a training worker subgraph, wherein the data worker subgraph is constituted by upstream nodes of stateful nodes, the training worker subgraph is constituted by the stateful nodes and downstream nodes of the stateful nodes, and on each side of the partitioned edge, a data sending node is added to the data worker subgraph and a data receiving node is added to the training worker subgraph, respectively;
a computation server, configured to provide a computation service for the received machine learning task, and comprising: a plurality of data worker units with each executing a data worker subgraph, and a plurality of training worker units with each executing a training worker subgraph, wherein the data worker subgraph and the training worker subgraph from a same computation graph are asynchronously executed; and
a scheduling server, configured to receive a request for adding a new data worker unit for a machine learning task, and allocate a new data worker unit for a specific machine learning task based on a mismatch indicator of data worker units over training worker units for different machine learning tasks.

13. A computing device, comprising:
a processor; and
a memory storing executable codes which, when executed by the processor, cause the processor to perform the method of claim 1.

14. A non-transitory machine-readable storage medium, storing executable codes which, when executed by a processor of an electronic device, cause the processor to perform the method of claim 1.

15. The method according to claim 4, wherein after the new CPU resource is allocated, the data worker subgraph is replicated, data that is different from data selected for existing CPU resources for execution of the data worker subgraph is selected from a training dataset for processing, and processed data is sent to the same data receiving node.

16. A computing device, comprising:
a processor; and
a memory storing executable codes which, when executed by the processor, cause the processor to perform the method of claim 10.

17. A non-transitory machine-readable storage medium, storing executable codes which, when executed by a processor of an electronic device, cause the processor to perform the method of claim 10.
